(19) United States
(12) Patent Application Publication
(10) Pub. No.: US 2002/0195503 A1
(43) Pub. Date: Dec. 26, 2002

(54) Vehicle service and maintenance tracking systems

(76) Inventors: Rodney F. Allen JR., Tallahassee, FL (US); William Daniel Norwood, Tallahassee, FL (US)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 09/772,706

(22) Filed: Jan. 30, 2001

(51) Int. Cl. B05B 9/00

(52) U.S. Cl. 239/144; 239/143; 239/311; 239/102.2; 239/318; 239/373; 366/108

(57) ABSTRACT

A system to track vehicle maintenance by removing service coupon data stored on a smart card. Identification and contract data are entered into a centralized database when a new vehicle is sold. A smart card is personalized and sent out when the database shows that a new vehicle owner has been added. The smart card is inserted into a remote terminal when the vehicle owner brings a vehicle in for service. The vehicle's current odometer reading and type of service is entered into a vehicle maintenance program. The appropriate service coupon is removed from the smart card and the current odometer reading and type of service for the vehicle is stored in the remote terminal. The remote terminal downloads the data back to the database the appropriate time. After data has been collected the system administrator can run reports and manipulate data for analysis and customer to dealer reimbursement purposes.

### CROSS-REFERENCE TO RELATED APPLICATIONS

This application is related to our applications Ser. No. 0x/xxx,xxx, “Web-Based Smart Card System and Method for Checking Card Holder Status Information to Verify Eligibility for Specific Events” and Ser. No. 0x/xxx,xxx, “Paperless System for the Display and Registry of Choices and the Collection of Data Entered Online and Offline in Elections and Surveys,” both filed concurrently herewith, and incorporated by reference herein as if set forth in full.

### STATEMENT REGARDING FEDERALLY SPONSORED RESEARCH DEVELOPMENT

Not Applicable

### REFERENCE TO A MICROFICHE APPENDIX

Not Applicable

### BACKGROUND OF THE INVENTION

The present invention relates to a system to monitor and maintain vehicle maintenance information. Particularly, the system relates to the removal of information pertaining to scheduled vehicle service and maintenance from a smart card having imbedded in the memory thereof service and other information which has been copied from a central database record and stored on a smart card.

Currently, vehicle owners use coupon books for their maintenance plans. Despite advances in the service related industries, coupon books are frequently lost or misplaced when the vehicle is brought in for service, causing unnecessary delays. Because of poor record keeping or non-transferred data, a search for maintenance due on a vehicle may take more than a normal amount of time, or may not produce any records at all. A vehicle owner is also required to complete and maintain paper forms and receipts for vehicle service. These too, may be lost or incomplete and delay the scheduled maintenance.

The present invention replaces the currently used paper based automotive maintenance tracking system. The invention replaces the coupon books currently used by vehicle owners for their maintenance plans.

The present invention is based upon Internet batch processing using a smart card. Smart cards contain microprocessor chip technology. The chip performs functions that traditional maintenance tracking cannot. A smart card system eliminates paperwork and the need for a vehicle owner to complete redundant, time-consuming forms. The invention also offers one device that can access multiple services, networks, and the Internet thereby reducing the number of cards a user must carry.

Smart cards may be used in contact with a smart card reader or may be used without physical contact, where the card is read from a distance. Smart cards provide data portability and security, and may be provided at a low cost depending upon their capacity and quantities.

Smart cards previously described for tracking vehicle maintenance have the disadvantage of possibly running out of memory as information is added to the card. Previously described systems add data each time the vehicle receives maintenance. Because smart cards have a finite amount of memory, this type of system may encounter functionality problems when the card memory is insufficient. See, for example, U.S. Pat. No. 6,170,742, “Method for Using a Smart Card for Recording Operations, Service and Maintenance Transactions and Determining Compliance of Regulatory and Other Scheduled Events.”

Certain aspects of smart cards and uses therefor are described, inter alia, in U.S. Pat. Nos. 5,679,945, “Intelligent Card Reader Having Emulation Features” and 5,969,316, “Smart Card for Offline Automated Meal Plans,” both issued to the assignee of the present application.

Accordingly, a system and method for a smart card coupon-based vehicle service and maintenance tracking is described.

### BRIEF SUMMARY OF THE INVENTION

It is the object of this invention to provide a system to track vehicle maintenance through the use of data in the form of a coupon stored on a smart card. According to the invention, information is entered into a centralized database connected to a data collection host when a new vehicle is sold. The data can be entered using the Internet based online administrative system, or through some other manual process outside the scope of this system.

The database is scanned at regular time intervals to determine if any new vehicle owners have been added. If a new vehicle owner has been added, a smart card is personalized for that new vehicle owner and sent out to the appropriate customer. It is understood that the customer may desire to take over the card personalization at some time in the future. A user interface for the personalization program accommodates this.

When a new vehicle owner brings a vehicle in for service, the owner presents the personalized smart card at the service counter. The smart card is inserted into a remote terminal connected to a network. The current odometer reading and type of service is entered into the vehicle maintenance program residing on the remote terminal. The appropriate service coupon record is removed from the smart card and a receipt is printed. The current odometer reading and type of service for each vehicle is stored in the remote terminal, and the smart card is returned to the vehicle owner.

At a scheduled time, the remote terminal dials out to the data collection host. The current odometer reading, type of service, and service coupon removed for each vehicle is transferred to the central database. Once the data has been collected, the system administrator can run reports and manipulate data for analysis and customer to dealer reimbursement purposes.

### BRIEF DESCRIPTION OF THE SEVERAL VIEWS OF THE DRAWINGS

FIG. 1 is an overall chart of the components of the system and their interrelationships;

FIG. 2 depicts the data fields associated with the drop down menu categories of the computer program and the relationship among the data fields in the database.

FIG. 3 diagrams the relationship of the system activities with regard to service and data events;

FIG. 4 depicts the appearance of the computer application log-on screen for creating records in the system;

FIG. 5 depicts the appearance of the computer application screen showing drop down menus for creating records in the system.

The invention is described more fully in the following description of the preferred embodiment considered in view of the drawings.

### DETAILED DESCRIPTION OF THE INVENTION

The invention comprises a system for tracking vehicle maintenance information associated with a predetermined vehicle. Included in the system is a central processing unit interconnected with a data collection host which is in turn associated with a database. The database houses records showing customers, dealers, and vehicle identification data, as well as types of vehicle maintenance programs, contracts and service maintenance coupons. These records are created and maintained on the database.

A smart card is produced upon entry of a record into the database. The smart card contains information corresponding to the record in the database. The data recorded on the smart card includes a predetermined contract, dealer, vehicle maintenance program, vehicle, and service coupon.

A remote terminal is interconnected in a network with the data collection host. The terminal is capable of reading the smart card and is programmed with predetermined activities related to the customer, dealer, and vehicle identification data, as well as vehicle maintenance program, contract and service coupon data. The remote terminal has the capacity to receive an input of data concerning a current odometer reading and a type of service with regard to a pre-identified vehicle associated with the smart card.

The invention has the means for removing from the smart card the record of the service coupon data that corresponds to the particular type of service entered into the remote terminal.

The invention also has the means for communicating from the remote terminal to the data collection host the data collected associated with a pre-identified vehicle. The data communicated from the remote terminal to the data collection host includes the current odometer reading, the type of service provided, and the service coupon data removed from a smart card. This information is stored in the database.

The individual vehicle maintenance programs created in the system of the invention comprise predetermined events. These events include: a time and mileage for vehicles to be checked, a service interval time, a rental option, additional benefits, maintenance agreement information, service coupons, and dealer identification.

The contracts created in the system of the invention are associated with a predetermined vehicle. The system's vehicle maintenance program generates the contract. At least one Coupon associated with service and maintenance events in the contract is copied to a smart card. Contract indicia are also copied to the smart card.

The invention is structured so that a given contract associated with a predetermined vehicle can be altered after creation of the vehicle maintenance program. Again, at least one coupon associated with maintenance events in the altered contract is copied to a smart card and the contract indicia are copied to a smart card.

The invention allows the generation of reports from the database with regard to predetermined selection criteria relating to records maintained in the database.

Alternatively, the invention involves a method for creating a system to track a vehicle's maintenance records. A vehicle maintenance program is created in a database upon a sale of a new vehicle by initializing and selecting predetermined options. A contract is created that provides parameters for the predetermined options. A vehicle dealer name is added to the contract. Customer information is entered into the database regarding a sold vehicle. The database is scanned at regular time intervals to determine if any new vehicle has been sold. A personalized smart card is created and sent to the customer. The smart card is inserted at the time of service into a remote terminal. The current odometer reading of the vehicle and type of service is entered into the remote terminal. The appropriate service coupon is electronically removed from the smart card. A receipt is printed. The information is stored in the remote terminal. The remote terminal dials out at a scheduled time to the data collection host. The information is transferred from the remote terminal to the data collection host. The information is stored in the database. Reports are designed and printed, and the data are manipulated for analysis and customer to dealer reimbursement purposes.

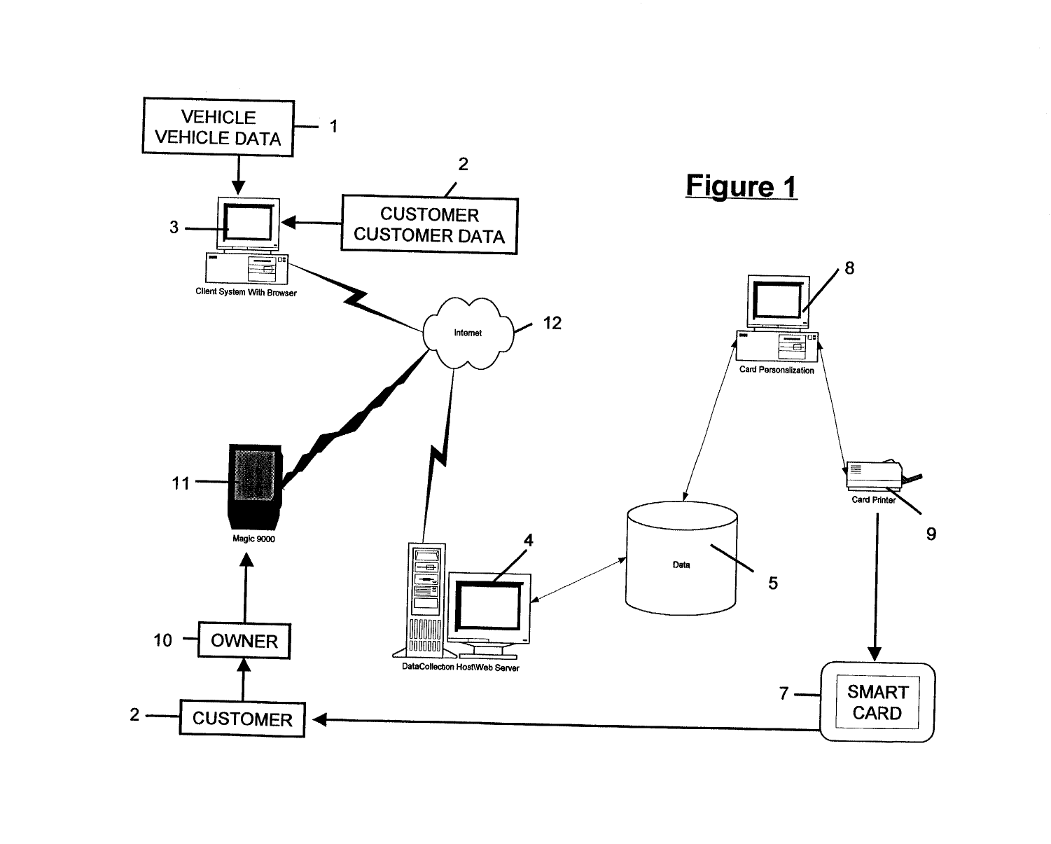

In the present system, data administration, maintenance, and reporting are carried out through a browser over the Internet as shown in FIG. 1. When a new vehicle 1 is sold, the customer 2 information is entered using a computer processing unit 3 interconnected to a data collection host 4 having a centralized database 5. As used herein, “customer” refers to a customer client of the system herein and includes by way of example, vehicle manufacturers, vehicle resellers, and the like. The data can be entered using the Internet based online administrative system, or through some other manual process outside the scope of this system.

The database 5 is scanned at regular time intervals to determine if any new vehicle owners 6 have been added. If a new vehicle owner 6 has been added, a smart card 7 is personalized 8 and printed 9 for that new vehicle owner 6 and sent out to the customer 2. The smart card 7 is personalized by adding customer 2 data to the card 7. Personalization 8 includes both the writing of data to the microprocessor on the card 7, and printing of custom data on the card 7 surface itself.

When a new vehicle owner 6 comes in for service on their vehicle 1 at a participating dealership 11, the owner 6 presents the personalized smart card 7 at the service counter 11 for service.

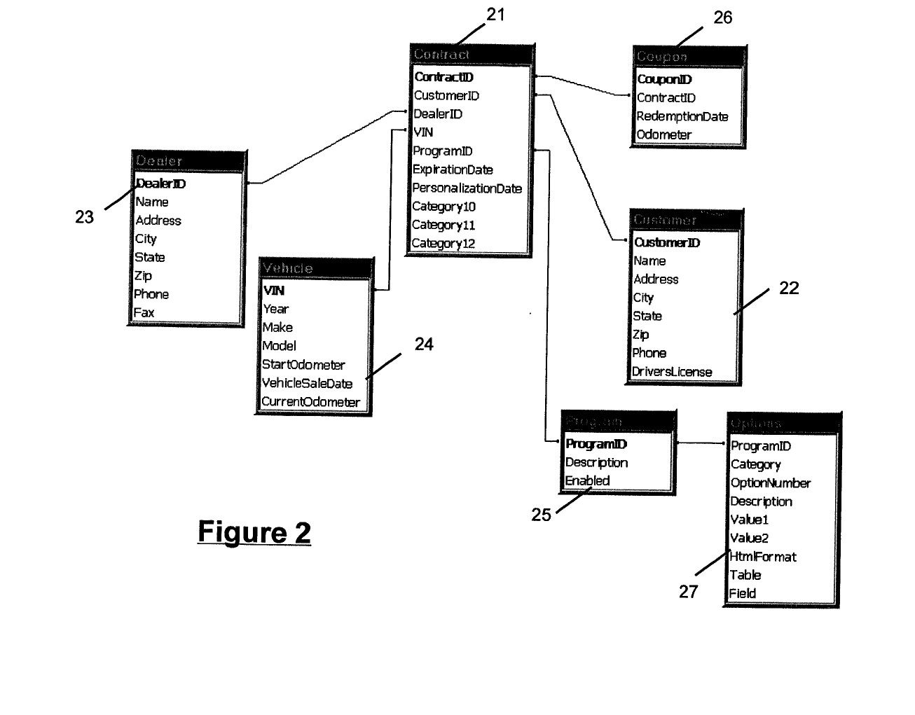

As shown in FIG. 2, data corresponding to the data fields of the database 5 determine the content of the smart card 7. The database 5 contains tables with data fields. The code file table functions as a “control” type table. The code file table holds options and values that are used within the other tables. There is a primary tag and a secondary tag. The primary tag is used as a grouping. The secondary tag is used for obtaining the specific value for the option needed. The following shows an example of a code file table:

| Code File 1 | Primary Tag | Value | Secondary Tag | Enabled |
|---|---|---|---|---|
| 1 | MAKE | 1 | Acura | Yes |
| 2 | MAKE | 2 | BMW | Yes |
| 3 | MAKE | 3 | Honda | Yes |

The code file contains the following data fields:

| CodeFileID | Number (Long) | CodeFileID - Not Currently Used |
|---|---|---|
| PrimaryTag | Text 20 | Primary Tag |
| SecondaryTag | Text 50 | Secondary Tag or Description. |
| Value | Number (Long) | Value in which is stored in related |
| | | tables. |
| Enabled | Yes/No | Enabled or Disabled. |
| | | If Disabled, no new contract |
| | | may be entered with this item. |
| Index | “TAG” | PrimaryTag, Ascending and |
| | | SecondaryTag, Ascending |

The contract table 21 contains the definition of a contract. The contract table 21 references the customer table 22, dealer table 23, vehicle table 24, vehicle maintenance program table 25, coupon table 26, and specific options 27 selected at time of contract execution as well as the expiration date of the contract. The following data fields are included in the contract table 21:

| ContractID | Number (Long) | ContractID |
|---|---|---|
| CustomerID | Number (Long) | Customer Number |
| | | Index to “Customer” |
| DealerID | Number (Long) | Dealer ID - Index to “Dealer” |
| VIN | Text 50 | Vehicle Identification Number |
| | | Index to “Vehicles” |
| ProgramID | Number (Long) | Program ID - Index to “Program” |
| ExpirationDate | Date/Time | Expiration Date of Contract |
| Personalization Date | Date/Time | Personalization Date |
| | | Null if not personalized. |
| Category10 | Number (Long) | Category 10 Setting |
| | | (for example: “Check Time and |
| | | Mileage” ) |
| Category 11 | Number (Long) | Category 11 Setting |
| | | (for example, “Service Interval”) |
| Category12 | Number (Long) | Category 12 Setting |
| | | (for example, “Rental Option”) |
| Index | “ContractID” | ContractID, Ascending |

The service coupon table 26 holds all coupons for every contract. A Coupon may be prepaid or otherwise. The example herein refers to a prepaid maintenance program. When a contract has been executed, all coupons are created. When a coupon is redeemed, the redemption date and mileage is update to signify that the coupon has been redeemed. The following data fields are included in the coupon table:

| CouponID | Text 25 | CouponID |
|---|---|---|
| ContractID | Number (Long) | Contract ID - Index to “Contract” |
| Redemption Date | Date/Time | Date in which the coupon has |
| | | been redeemed |
| Odometer | Number (Long) | Odometer Reading at time of |
| | | redemption |
| CouponValue | Currency | Dollar Value of Coupon for |
| | | Dealer Reimbursement |
| TerminalID | Number (Long) | Location of Terminal where |
| | | coupon was redeemed |
| Index | “CouponID” | CouponID, Ascending |

The customer table 22 contains all of the customer information. The following data fields are included in the customer table 22:

| CustomerID | Number (Long) | CustomerID |
|---|---|---|
| Name | Text 50 | First, Last, and Middle name |
| Address | Text 50 | Address |
| City | Text 15 | City |
| State | Text 2 | State Abbreviation |
| Zip | Text 10 | Postal Code |
| Phone | Text 12 | Phone Number |
| DriversLicense | Text 30 | Drivers License Number |
| Index | “CustomerID” | CustomerID, Ascending |

The dealer table 23 contains all of the dealer information. The following data fields are included in the dealer 23 table:

| DealerID | Number (Long) | Dealer ID |
|---|---|---|
| Name | Text 50 | Name |
| Address | Text 50 | Address |
| City | Text 15 | City |
| State | Text 2 | State |
| Zip | Text 10 | Zip |
| Phone | Text 12 | Phone |
| Fax | Text 12 | Fax |
| Index | DealerID | DealerID, Ascending |

The options table 27 contains the configuration of a vehicle maintenance program. The option table 27 is used for the actual entry of a contract. Each Program ID has multiple records within this table specifying all questions for the vehicle maintenance program. Questions are split up in categories for ease of entry, and to define Value 1 and Value 2. During the entry of the contract, the Description is displayed with the appropriate box specified by the HtmlFormat for input. The table and field specify where the input information is to be stored, and the maximum length of the input.

| ProgramID | Number (Long) | Program ID - Index to “Program” |
|---|---|---|
| Category | Number (Long) | Category - “CATEGORY” in the |
| | | CodeFile |
| OptionNumber | Number (Long) | Option Number - Option Number |
| | | within the Category |
| Description | Memo | Option Description |
| Value1 | Number (Long) | In Category “Check Time & Mileage” = |
| | | Contract # of Months. |
| | | In Category “Service Interval” = |
| | | # of miles between service. |
| | | In Category “Rental Option” = |
| | | # of rentals per year. |
| Value2 | Number (Long) | In Category “Check Time & Mileage” = |
| | | Contract # of Miles. |
| HtmlFormat | Number (Long) | Format in which HTML |
| | | displayed or input |
| | | “HTML” in the Code File. |
| Table | Text 20 | Table where input data are stored. |
| Field | Text 20 | Field within the table where the input |
| | | data are stored. |
| Index | “Program” | ProgramID, Ascending, Category, |
| | | Ascending, and Option Number, |
| | | Ascending. |

The following is an example of an options table 27:

| | Category | Option | Description | Value | Value | HtmlFor | Table | Field |
|---|---|---|---|---|---|---|---|---|
| 1 | Customer | 1 | CustomerID | | | TextBox | Custo | CustomerI |
| 1 | Customer | 2 | Name | | | TextBox | Custo | Name |
| 1 | Customer | 3 | Address | | | TextBox | Custo | Address |
| 1 | Customer | 4 | City | | | TextBox | Custo | City |
| 1 | Customer | 5 | State | | | TextBox | Custo | State |
| 1 | Customer | 6 | Zip | | | TextBox | Custo | Zip |
| 1 | Customer | 7 | Phone | | | TextBox | Custo | Phone |
| 1 | Customer | 8 | Drivers | | | TextBox | Custo | DriversLice |
| 1 | Vehicle | 1 | VIN | | | TextBox | Vehicle | VIN |
| 1 | Vehicle | 2 | Year | | | TextBox | Vehicle | Year |
| 1 | Vehicle | 3 | Make | | | TextBox | Vehicle | Make |
| 1 | Vehicle | 4 | Model | | | TextBox | Vehicle | Model |
| 1 | Vehicle | 5 | Start | | | TextBox | Vehicle | StartOdom |
| 1 | Vehicle | 6 | Vehicle Sale | | | TextBox | Vehicle | VehicleSale |
| 1 | Vehicle | 7 | Current | | | TextBox | Vehicle | CurrentOdo |
| 1 | Dealer | 1 | DealerID | | | TextBox | Dealer | DealerID |
| 1 | Dealer | 2 | Name | | | TextBox | Dealer | Name |
| 1 | Dealer | 3 | Address | | | TextBox | Dealer | Address |
| 1 | Dealer | 4 | City | | | TextBox | Dealer | City |
| 1 | Dealer | 5 | State | | | TextBox | Dealer | State |
| 1 | Dealer | 6 | Zip | | | TextBox | Dealer | Zip |
| 1 | Dealer | 7 | Phone | | | TextBox | Dealer | Phone |
| 1 | Dealer | 8 | Fax | | | TextBox | Dealer | Fax |
| 1 | Check Time & | 1 | 12 | 12 | 1500 | Radio | Contra | Category10 |
| 1 | Check Time & | 2 | 24 | 24 | 3000 | Radio | Contra | Category10 |
| 1 | Check Time & | 3 | 36 | 36 | 4500 | Radio | Contra | Category10 |
| 1 | Check Time & | 4 | 48 | 48 | 6000 | Radio | Contra | Category10 |
| 1 | Service | 1 | 3,750 Miles | 3750 | | Radio | Contra | Category11 |
| 1 | Service | 2 | 7.500 Miles | 7500 | | Radio | Contra | Category 11 |
| 1 | Rental Option | 1 | No Rental | 0 | | Radio | Contra | Category12 |
| 1 | Rental Option | 2 | 1 Day Rental | 2 | | Radio | Contra | Category 12 |
| 1 | Additional | 1 | Additional | | | Text | | |
| 1 | Maintenance | 1 | Maintenance | | | Text | | |

The vehicle maintenance program table 25 contains all vehicle maintenance program identifications and descriptions. The vehicle maintenance program table 25 allows for the creation of multiple vehicle maintenance programs. Vehicle maintenance programs may be disabled so that no more contracts under that specific program may be sold. However, the program still has the ability to support the contract and its remaining coupons. The following data fields are included in the vehicle maintenance program table 25:

| ProgramID | Number (Long) | Program ID |
|---|---|---|
| Description | Text 50 | Program Description |
| Enabled | Yes/No | Enabled or Disabled. |
| | | If Disabled, no new contracts may |
| | | be entered. |
| Index | ProgramID | Program ID, Ascending |

The vehicle table 24 contains all vehicle information. The following data fields are included in the vehicle table 24:

| VIN | Text 50 | VIN Number |
|---|---|---|
| Year | Number (Long) | Vehicle Year |
| Make | Number (Long) | Vehicle Make |
| | | “MAKE” in the CodeFile |
| Model | Text 15 | Vehicle Model |
| StartOdometer | Number (Long) | Odometer reading at time of |
| | | sale of the contract. |
| VehicleSaleDate | Date/Time | Date of sale of the vehicle. |
| CurrentOdometer | Number (Long) | Current Odometer Reading |
| | | Same as LastRedemption reading or |
| | | Sale of Contract reading |
| Index | Primary Key | VIN, Ascending |

Referring again to FIG. 1, the scanning of the database 5 for new vehicle owners 6 initiates the creation of a personalized smart card 7. It is understood that a customer 2 may desire to take over the card personalization 8 at some time in the future. Therefore, the computer program includes a user interface for the personalization program.

The smart card 7 is personalized by adding customer 2 data to the card. Personalization 8 includes both the writing of data to the microprocessor on the card 7, and printing of custom data on the card 7 surface itself. The smart card 7 includes smart card 7 memory configuration in typical bytes:

| | |
|---|---|
| Capacity | xxx |
| Bearer File | 112 |
| Bearer File Header | 24 |
| Coupon File | 400 |
| Coupon File Header | 24 |
| Total Remaining | yyy |

Examples of data table information that may be transferred from the database 5 to the smart card 7 follow:

Bearer File - Transparent File

| | | | |
|---|---|---|---|
| Contract ID | 4 | BCD | Contract ID |
| Customer ID | 4 | BCD | Customer ID |
| Dealer ID | 8 | Alpha | Dealer ID - Only the dealer that sold |
| | | | the coupons can redeem the coupons. |
| Program ID | 4 | BCD | Program ID |
| Expiration Date | 4 | BCD | MMDDYYYY - Contract Expiration |
| | | | Date |
| Expiration | 3 | BCD | Contract Expiration Odometer |
| Odometer | | | |
| Name | 32 | ASCII | Customer Name |
| VIN | 17 | ASCII | Vehicle Identification Number |
| Make | 10 | ASCII | Vehicle Make |
| Model | 16 | ASCII | Vehicle Model |
| Year | 4 | BCD | Vehicle Year |
| RFU | 06 | N/A | Reserved For Future Use |
| Total Bytes | 112 | | |

Coupon File - Record file

| | | | |
|---|---|---|---|
| Coupon ID | 3 | BCD | Coupon ID |
| Coupon Type | 1 | HEX | Coupon Type |
| | | | 0×01 = Maintenance Coupon |
| | | | 0×02 = Rental Coupon |
| Redemption Date | 4 | BCD | Redemption Date - 0×00 after |
| | | | personalization |
| Odometer | 3 | BCD | Odometer reading at time of redemp- |
| | | | tion - 0×00 after personalization |
| RFU | 5 | N/A | Reserved For Future Use |
| Total Bytes | 16 | | |
| Total Bytes * 25 | 400 | | |

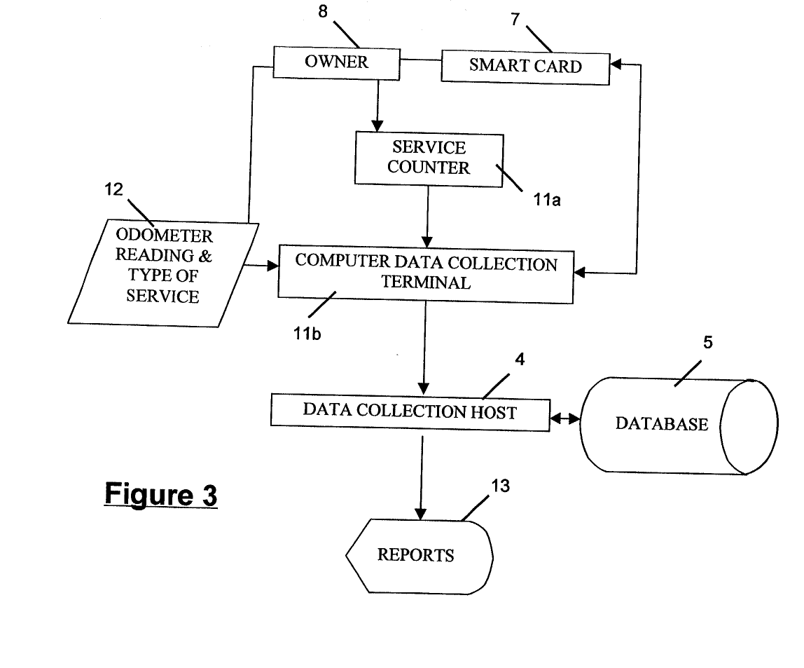

With reference to FIG. 3, when a new vehicle owner 6 comes in for service on their vehicle 1 at a participating dealership 11 the vehicle owner 6 present the personalized smart card 7 at the service counter 11a. The smart card 7 is inserted into a remote terminal 11b connected to a network and the current odometer reading and type of service 12 is entered at the remote terminal 11b. The appropriate prepaid service coupon is removed from the smart card 7 and a receipt is printed. The current odometer reading and type of service 12 for each vehicle 1 is stored in the remote terminal 11b, and the smart card 7 is returned to the vehicle owner 6.

The remote terminals 11b dials into the data collection host 4 each 24-hour period. If the remote terminal 11b has collected data, the remote terminal 11b sends its batch to the data collection host 4, and receives any configuration updates from the data collection host 4. If the remote terminal 11b has not collected any data it contacts the data collection host 11b, and receives any configuration updates from the data collection host 11b.

Once communications are established, the data collection host 4 requests data from the remote terminal 11b. As the data collection host 11b receives the data, the data collection host 4 verifies data integrity, parses the data, and stores the data in the central database 5. Once all data have been received, the data collection host 4 determines whether any configuration data must be sent to the remote terminal 11b. If there is data to send, the data collection host 4 forwards it to the remote terminal 11b. If there is no data, the communication session ends. The data collection host 4 contains extensive logging capabilities, and all aspects of the communication session are logged in real time for future analysis if the need should arise.

As a remote terminal 11b based system, the remote terminal 11b dials into the data collection host 4 automatically on a nightly basis and settles all the transactions for that day with the data collection host 4. The data collection host 4 stores all the information on the customer 2. If there are problems in settling to the data collection host 4, the transactions remain in the remote terminal 11b until settlement occurs.

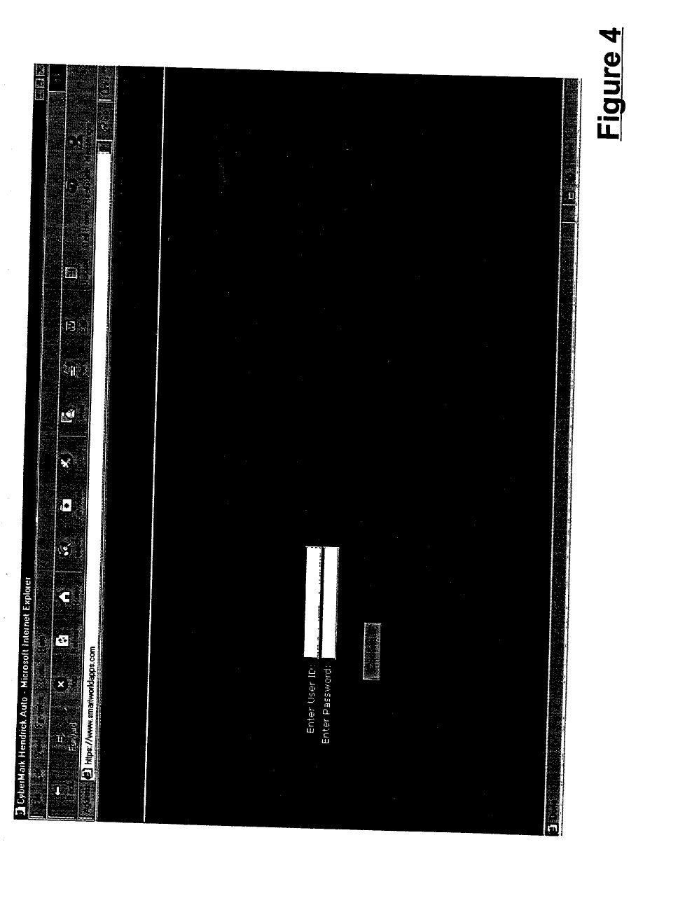

FIG. 4 shows the computer log-on screen of the application. A username and password must be supplied before the application proceeds. If the user does not have appropriate security clearance the user is asked to contact the user's service representative. If the user does have appropriate security clearance to the web site, the user is only allowed to access those areas their security level dictates. All data being moved between the server and the client is encrypted to protect the sensitive and proprietary nature of the data. This encryption is implemented using digital certificates and the existing Secure Sockets Layer (SSL) infrastructure.

After entering a valid username and password, the application allows access to all authorized users to utilize all of the menus available as depicted in FIG. 4. These menus are:

Vehicle maintenance programs, with the option to add, edit or delete vehicle maintenance programs that are used to set up contracts: Contracts, with the option to add, edit or delete contracts that are used in conjunction with available vehicle maintenance programs; Dealer, with the option to add, edit or delete dealer information from the available vehicle maintenance programs; and Reports, with the option to print available contracts, retrieve information on the current status of contracts, retrieve information on personalized cards, retrieve information on dealer balances and vehicle maintenance program definitions. Some reports can be generated based on a specified time frame while others do not require dates.

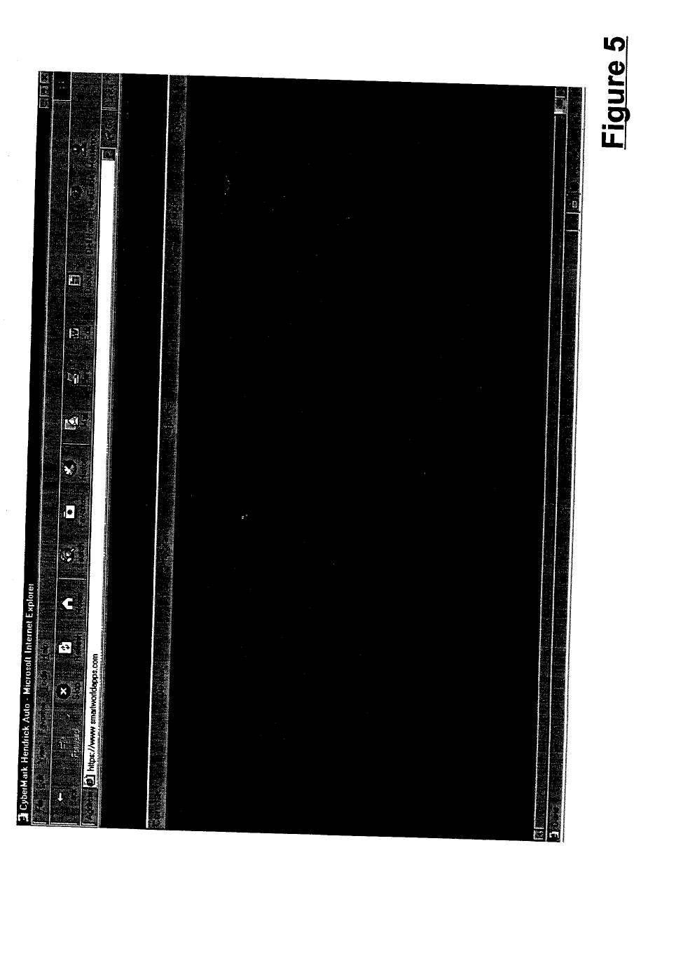

As shown in FIGS. 2 and 5, the menus relate to data tables that are interrelated. Each menu includes data fields. Each of these menus and their associated functions are now described.

Vehicle Maintenance Program Menu

To add a new vehicle maintenance program, a user selects “add program” under the program menu on the main screen. Authorized users select this option each time a new vehicle maintenance program is created. Under this menu, authorized users can add new vehicle maintenance programs, edit existing vehicle maintenance programs or delete existing vehicle maintenance programs.

Initially when adding a new vehicle maintenance program, the vehicle maintenance program identification number is given in sequential order. Therefore, vehicle maintenance programs that have been successfully created and added are assigned lower identification numbers than the next vehicle maintenance program to be created and added. As an example, the new vehicle maintenance program may be given the number “5” because it is the fifth one that has been added to the system.

Users are also asked to give a vehicle maintenance program description of what the new vehicle maintenance program pertains to as well. Each contract under this vehicle maintenance program reflects the description and set up under this new vehicle maintenance program so the description should be as well defined as possible.

Users also have the ability to enable the vehicle maintenance program or not. This allows the vehicle maintenance program to be active for each contract that is created. If users decide to not check the enabled box, future contracts cannot be created or added using this particular vehicle maintenance program.

To add vehicle maintenance programs, users must set up the vehicle maintenance program specifications. To do this, a user clicks on any item on the left hand side of the screen and follows the instructions. The specifications for the vehicle maintenance program are stored in a vehicle maintenance program table. This table holds all vehicle maintenance program identifications and descriptions.

The first option in vehicle maintenance program set up is to determine the time and mileage the vehicle should be checked. The number of months and the mileage can be set to any number depending on the vehicle maintenance program. After entering in the desired information, a user clicks on the save button. As an example, the service may be set to end after 36 months and 36,000 miles.

Also, a vehicle maintenance program description is required for this option. Users can use this opportunity to name the service according to the applicable specifications. A user must again select the save button after each option in order to save the entered information. If the information is not saved, the vehicle maintenance program does not save any information, causing the user to recreate a new vehicle maintenance program each time. Also, if the information is incorrect or needs to be changed, the user must click on the reset button. This action cancels the information allowing the user to start over.

The service interval option provides the ability to set the standards for the service interval for the specified vehicle maintenance program. Again, as an example, the option for service may be set at every 5,000 miles. An option description is also needed to label this portion of the vehicle maintenance program. Users can set the service for any number of miles according to the vehicle maintenance program specifications. After the desired information has been entered, the user clicks the save button.

The rental option provides users with the ability to add vehicle rentals to the specified vehicle maintenance program. This is an added option in case services are longer than the specified time frame. Rental coupons are defined as an annual number. After entering the desired information, a user clicks the save button. As an example, the number of vehicle rentals may be set at two (2) per year.

The additional benefits option provides users with the ability to add benefits to the vehicle maintenance program. Additional benefits can depend on the vehicle maintenance program's specifications. These specifications vary from program to program. After entering the desired information, a user clicks the save button. For example, the additional benefits for a particular vehicle maintenance program may be an additional gas coupon to be used with the rental option.

The maintenance agreement option allows the user to enter the maintenance agreement information into the vehicle maintenance program that is being created and added. Maintenance agreements vary from program to program. After entering the desired information, a user clicks on the save button. For example, the maintenance agreement may be set to include a free oil change after three full service visits.

The coupons option provides authorized users with the ability to utilize the fields that have been standardized into the prepaid service coupons application. Users have the ability to change the fields if needed. To change the fields, a user types in the space provided. For example, if a user does not want to use “customerID” as one of the fields, that user types in the information to replace that displayed text. As a further example, a user may replace “customerID” by typing “customernumber” in its place. To display the fields, a user clicks the enabled boxes and then clicks the save button. If a user does not want to use certain fields, then the user does not check the enabled box.

Similar to the customer information options, the vehicle information input provides the opportunity to change the field names as well. Once a field has been changed, a user clicks the enabled boxes to display the text and then clicks the save button. If a user does not want to use a certain field, the user does not check the enabled box.

The dealer information can be changed according to the vehicle maintenance program specifications. The fields can be altered in a similar manner as that discussed for the customer information and the vehicle information options. To enable the fields, the user checks the enabled boxes. After the desired information has been entered, a user clicks the save button. If a user decides to not use a particular field, a user does not check the enabled box.

Vehicle maintenance programs can be edited in the prepaid service coupon system as well. The edit option enables users to change information to the vehicle maintenance program as needed. To edit a vehicle maintenance program, a user chooses “edit program” under the program option menu. A user is then be prompted to select the vehicle maintenance program number to be changed. Once the program number has been chosen, the user follows the instructions on the screen to edit the necessary information.

In addition to editing vehicle maintenance programs, a user can also opt to delete existing vehicle maintenance programs. This is a useful tool in cases where vehicle maintenance programs have expired or are no longer in use. To delete vehicle maintenance programs, a user selects “delete program” under the program option menu. After selecting the vehicle maintenance program number, a user clicks the “delete” button.

Contracts Menu

After the vehicle maintenance program has been created and added to the system, contracts can now be created and added according to the information specified from the vehicle maintenance program. To add a contract, a user selects “add new” under the contract options menu. After clicking on the “add new” contract option, the contract ID number is sequentially chosen according to the number of the previously added contracts. A user must then select the program identification number for this new contract. After selecting the desired vehicle maintenance program, a user clicks the save button. A screen appears verifying that a new contract has been added by displaying that the information has been saved.

Similar to the vehicle maintenance program menu, the contract menu provides the options to set the time and mileage for vehicles to be checked, the service interval time and the rental options. To set the options on the contract, a user clicks on the buttons on the left hand side. Every time an option is selected from the left, the vehicle maintenance program options that were set previously are displayed. If the user decides to add the option from the vehicle maintenance program to the contract, he selects the button and clicks the save button. This is the process for each option in the contract menu. If the user decides to not add the given options, the button is not selected. However, the user must click the save button to proceed to the next step.

Similar to the “check time and mileage” option, users can also add the “service interval” in this part of the contract as well. To add this option, a user selects the displayed button and clicks the save button.

The final option users must add to the contract is the rental option. If the user decides to add this option, then the button must be selected and the information must be saved. If the user does not want this option, then the button is not selected. The user must click the save button to proceed to the next step.

Dealer Menu

To add dealer information to the newly created and added contract, a user clicks on “add dealer” under the dealer option menu. Because the fields have been set in the vehicle maintenance program, the user enters the desired information and then clicks the save button.

Reports Menu

Users can print contracts if desired. To print contracts, a user selects the contract number and clicks “ok”. The information on the given contract is displayed. As with other web applications, a user chooses the print icon on the browser task bar to print.

The contract status report provides the status of all contracts in the system. This report outlines the prepaid service coupon number, redemption odometer, coupon value and location that the coupons were redeemed. A user may print this report as described above.

The card personalization report requires a beginning and ending date range input before a user can generate the report. A user may also generate reports for a particular day. A start date and an end date must be entered before the card personalization report can be generated. After a specific date range has been entered into the system, the card personalization report is generated. As an example, a particular report may provide information on the number of cards that are valid throughout the system including contract ID, customer ID, Dealer ID, Program ID, the date the card was issued, the expiration date (of the card), and the odometer reading upon expiration. Each time a new cardholder is added to the database, the card is personalized for that individual customer and sent out to the appropriate customer for distribution.

The dealer balance report requires the user to enter a date range before the report is generated. This report can also be generated for a specific day. A user must enter a start date and an end date before the dealer balance report is generated. After entering the date range, the dealer balance report is displayed outlining the dealer ID, customer ID, coupon ID, coupon types, redemption date, redemption odometer and the coupon value. This option is only available to authorized users.

The vehicle maintenance program definition report provides the user with a more in-depth definition of the vehicle maintenance program report. This report outlines the category, option number, description, display format, value 1 and 2, where the information was saved, and the field. This report is limited only to authorized users and can be printed.

Examples of printed reports are listed next.

Contract

The format of a contract is determined largely by the vehicle maintenance program options associated with the vehicle maintenance program to which the contract applies. The contract representation is dynamically generated based on these options. An example contract printout might look something like:

| Contract ID: | 000001 | Automotive Maintenance for Acura | |
|---|---|---|---|
| MM/DD/YYYY | | | |
| Customer Information | | Vehicle Information | |
| Name: | John Q Motorhead | Year, Make, Model: | 1999 Acura Legend SE |
| Street Address: | 1 Victory Lane | Model Number: | 123456 |
| City, ST, Zip: | Daytona, IN 00400 | VehicleID Number: | ABCDEFVIN000001 |
| Phone: | 400-001-1999 | Date of Sale: | 01/01/1999 |
| Drivers License: | 1234-1234-1234 | Vehicle Sale/Lease Date: | 01/01/2000 |
| | | Current Mileage: | 000,001 |
| Selling Dealer Information | | Lien Information | |
| Name: | Isell Cars | LienHolder Name: | I. M. Loanman |
| Address: | 1 Dealership Road, Detroit, | Lienholder Address: | 001 Wall Street |
| | MI 28867 | | New York, NY 00123 |
| Phone: | 800-227-7253 | | |
| Check Time and Mileage: | 24 | Service Interval: | 7,500 Miles |
| | Months/24,000 | | |

Additional Benefits:
(This section of the report contains the text that was typed in for the
contract under the additional benefits field.)
Maintenance:
(This section of the report contains the text that was typed in for the
maintenance portion of the contract.)
End of Report

Contract Status Report

This report shows the current status of a contract. An example contract status report printout might look something like:

Contract Status Report

| | | |
|---|---|---|
| Report Date: MM/DD/YYYY | | |
| ContractID: 00001 Program | ID: Program01 | CustomerID: 00666 |
| Expiration Date: 12/25/2020 | | |
| Dealer ID: 91326 | | |
| Personalization Date: 12/25/2018 | | |
| VIN: VIN1234567890 | | |

| | Redemption | Redemption | Coupon | Redeemed At |
|---|---|---|---|---|
| Coupon ID | Date | Odometer | Value | Terminal |
| AAAAnnnnnnXXXXXXXXSnnnnnn | 01/01/2000 | 3000 | $ 999.99 | 000000001 |
| AAAAnnnnnnXXXXXXXXSnnnnnn | 03/01/2000 | 6000 | $ 999.99 | 000000001 |
| AAAAnnnnnnXXXXXXXXSnnnnnn | 07/01/2000 | 9000 | $ 999.99 | 000000001 |
| AAAAnnnnnnXXXXXXXXSnnnnnn | 10/01/2000 | 12000 | $ 999.99 | 000000001 |
| AAAAnnnnnnXXXXXXXXSnnnnnn | 01/01/2001 | 15000 | $ 999.99 | 000000001 |
| AAAAnnnnnnXXXXXXXXSnnnnnn | 02/01/2000 | 18000 | $ 999.99 | 000000001 |
| AAAAnnnnnnXXXXXXXXSnnnnnn | 05/01/2000 | 21000 | $ 999.99 | 000000001 |
| AAAAnnnnnnXXXXXXXXSnnnnnn | 05/01/2000 | 21000 | $ 999.99 | 000000001 |
| AAAAnnnnnnXXXXXXXXSnnnnnn | 05/01/2000 | 21000 | $ 999.99 | 000000001 |
| End of Report | | | | |

Card Personalization Report

This report indicates the cards that were personalized within a given timeframe. An example contract printout might look something like:

Card Personalization Report

Report Start Date: MM/DD/YYYY
Report End Date: MM/DD/YYYY

| Card | Customer | Dealer | Program | Card | Exp | Exp | Service |
|---|---|---|---|---|---|---|---|
| ID | ID | ID | ID | Issued | Date | Odometer | Interval |
| 00000001 | 00000001 | 00000001 | 00001 | Dec. 12, 2000 | Dec. 12, 2011 | 030000 | 7500 |
| 00000002 | 00000002 | 00000002 | 00001 | Dec. 12, 2000 | Dec. 12, 2011 | 015000 | 3750 |
| 00000003 | 00000003 | 00000003 | 00001 | Dec. 12, 2000 | Dec. 12, 2011 | 030000 | 3750 |
| 00000004 | 00000004 | 00000004 | 00001 | Dec. 12, 2000 | Dec. 12, 2011 | 030000 | 7500 |
| 00000005 | 00000005 | 00000005 | 00001 | Dec. 12, 2000 | Dec. 12, 2011 | 030000 | 7500 |
| 00000006 | 00000006 | 00000006 | 00001 | Dec. 12, 2000 | Dec. 12, 2011 | 030000 | 3750 |
| 00000007 | 00000007 | 00000007 | 00001 | Dec. 12, 2000 | Dec. 12, 2011 | 030000 | 7500 |
| 00000008 | 00000008 | 00000008 | 00001 | Dec. 12, 2000 | Dec. 12, 2011 | 030000 | 7500 |
| 00000009 | 00000009 | 00000009 | 00001 | Dec. 12, 2000 | Dec. 12, 2011 | 030000 | 7500 |

End of Report

Program Definition Report

The program definition report details the options contained in a program definition. An example program definition report printout might look something like:

Program Definition Report For Program 000001

Report Date: MM/DD/YYYY

| | Option | | Display | | | Save In | |
|---|---|---|---|---|---|---|---|
| Category | Number | Description | Format | Value1 | Value2 | Table | Field |
| Customer | 000001 | Name | Text | | | Customer | Name |
| Customer | 000002 | Address | Text | | | Customer | Addr |
| Customer | 000003 | Phone | Text | | | Customer | Name |
| Customer | 000004 | City,St,Zip | Text | | | Customer | Addr |
| Dealer | 000001 | ID | Text | | | Dealer | ID |
| Time/Miles | 000001 | 12 Months/15,000 mi | Radio | 12 | 15000 | Contract | Category10 |
| Time/Miles | 000002 | 24 Months/30,000 mi | Radio | 24 | 30000 | Contract | Category10 |
| Service Int | 000001 | 3750 miles | Radio | 3750 | | Contract | Category11 |
| Service Int | 000002 | 7000 miles | Radio | 7000 | | Contract | Category11 |

End of Report

Dealer Balance Report

This report indicates the prepaid service coupons used in a given time period for a given dealer. An example dealer balance report printout might look something like:

Dealer Balance Report

Report Start Date: MM/DD/YYYY
Report End Date: MM/DD/YYYY

| Dealer | | | | | | | |
|---|---|---|---|---|---|---|---|
| Service Coupon | Customer | Coupon | | | | Coupon Redemption | Redemption |
| D | ID | ID | Type | Date | Odometer | Interval | Value |
| 00000001 | 00000001 | AAAAnnnnnnXXXXXXXXSnnnnnn | 00001 | MM/DD/YYYY | 030000 | 7500 | $ 1.01 |
| | 00000002 | AAAAnnnnnnXXXXXXXXSnnnnnn | 00001 | MM/DD/YYYY | 030000 | 7500 | $ 2.10 |
| | 00000003 | AAAAnnnnnnXXXXXXXXSnnnnnn | 00001 | MM/DD/YYYY | 030000 | 7500 | $ 3.20 |
| | 00000004 | AAAAnnnnnnXXXXXXXXSnnnnnn | 00001 | MM/DD/YYYY | 030000 | 7500 | $ 4.30 |
| Total | | | | | | | $ 10.61 |
| 00000002 | 00000666 | AAAAnnnnnnXXXXXXXXSnnnnnn | 00001 | MM/DD/YYYY | 030000 | 7500 | $ 1.40 |
| | 00000667 | AAAAnnnnnnXXXXXXXXSnnnnnn | 00001 | MM/DD/YYYY | 030000 | 7500 | $ 2.50 |
| | 00000668 | AAAAnnnnnnXXXXXXXXSnnnnnn | 00001 | MM/DD/YYYY | 030000 | 7500 | $ 3.60 |
| | 00000669 | AAAAnnnnnnXXXXXXXXSnnnnnn | 00001 | MM/DD/YYYY | 030000 | 7500 | $ 4.70 |
| Total | | | | | | | $ 12.20 |

End of Report

In accordance with another aspect of the invention, the system described above may be facilitated over an intranet.

Having described the invention in detail, those skilled in the art will appreciate that, given the present disclosure, modifications may be made to the invention without departing from the spirit of the inventive concept herein described. Rather, it is intended that the scope of the invention be determined by the appended claims.

What is claimed is:

1. A system for tracking vehicle maintenance information associated with predetermined vehicle comprising:
a central processing unit interconnected with a data collection host having a database in which a plurality of records concerning customer, deal, and vehicle identification data; and vehicle maintenance program, contract and service coupon data are created and maintained;
a smart card produced upon entry of a record into the database, the smart card containing information corresponding to the record in the database and having predetermined contract, dealer, vehicle maintenance program, vehicle, and service coupon data recorded thereon;
a remote terminal interconnected in a network with the data collection host; such remote terminal capable of reading the smart card and programmed with predetermined activities related to the customer, dealer, and vehicle identification data; and vehicle maintenance program, contract and service coupon data; said remote terminal having input for receiving data concerning a current odometer reading and a type of service with regard to a pre-identified vehicle associated with the smart card;
means for removing the record of the service coupon data from the smart card corresponding to a plurality of type of service entered into the remote terminal;
means for communicating from the remote terminal to the data collection host the data collected associated with a pre-identified vehicle and relating to the current odometer reading, the type of service provided, and the service coupon data removed from a smart card.

2. The system of claim 1 wherein the vehicle maintenance program comprises predetermined events with respect to one or more of the group of a time and mileage for vehicles to be checked, a service interval time, a rental option, additional benefits, maintenance agreement information, service coupons, and dealer identification.

3. The system of claim 2 wherein the contract associated with a predetermined vehicle is generated by the vehicle maintenance program and at least one coupon associated with maintenance events in the contract is copied to a smart card.

4. The system of claim 2 wherein the contract associated with a predetermined vehicle is generated by the vehicle maintenance program and contract indicia are copied to a smart card.

5. The system of claim 2 wherein the contract associated with a predetermined vehicle can be altered after creation of the vehicle maintenance program and at least one coupon associated with maintenance events in the contract is copied to a smart card.

6. The system of claim 2 wherein the contract associated with a predetermined vehicle can be altered after creation of the vehicle maintenance program and the contract indicia are copied to a smart card.

7. The system of claim 1 wherein reports are generated from the database with regard to predetermined selection criteria relating to records maintained in the database.

8. A method for creating a system to track a vehicle's maintenance records, comprising:
creating a vehicle maintenance program in a database upon a sale of a new vehicle by initializing and selecting predetermined options;
creating a contract that provides parameters for the predetermined options;
adding a vehicle dealer name to the contract;
entering customer information on a sold vehicle into the database;
scanning the database at regular time intervals to determine if a vehicle has been sold;
creating a personalized smart card which is sent to the customer;
inserting the smart card at the time of service into a remote terminal;
entering the current odometer reading of the vehicle and type of service;
electronically removing the appropriate service coupon from the smart card;
printing a receipt;
storing the data in the remote terminal;
dialing out by the remote terminal at a scheduled time to the data collection host;
transferring the data from the remote terminal to the data collection host;
storing the data in the database;
running and printing reports; and,
manipulating data for analysis and customer to dealer reimbursement purposes.
